(19) United States
(12) Patent Application Publication
(10) Pub. No.: US 2011/0223487 A1
(43) Pub. Date: Sep. 15, 2011

(54) ELECTROCHEMICAL CELL WITH SINTERED CATHODE AND BOTH SOLID AND LIQUID ELECTROLYTE

(75) Inventors: Lonnie G. Johnson, Atlanta, GA (US); Stephen Buckingham, Ypsilanti, MI (US)

(73) Assignee: EXCELLATRON SOLID STATE LLC, Atlanta, GA (US)

(21) Appl. No.: 13/038,748

(22) Filed: Mar. 2, 2011

Related U.S. Application Data
(63) Continuation-in-part of application No. 12/198,421, filed on Aug. 26, 2008.
(60) Provisional application No. 60/968,638, filed on Aug. 29, 2007.

(51) Int. Cl. H01M 10/0562; H01M 4/52; H01M 4/50; H01M 4/62; H01M 4/36

(52) U.S. Cl. 429/319; 429/218.1; 429/223; 429/231.3; 429/224; 429/221; 429/217; 429/304; 429/322; 429/231.95

(57) ABSTRACT

An electrochemical cell has an anode of electrochemically-active material; a cathode of electrochemically-active, porous, liquid-permeable, sintered, ceramic material; and a solid-state, liquid-impermeable electrolyte medium disposed between the anode and the cathode. The electrolyte may be a layer of glass or a layer of glass ceramic, or may be a combination of a layer of glass and a layer of glass ceramic. The cell may further contain a liquid electrolyte diffused throughout the cathode.

### RELATED APPLICATIONS

This application is a continuation-in-part of U.S. patent application Ser. No. 12/198,421 filed Aug. 26, 2008, published Apr. 9, 2009, under publication number US 2009/0092903, which in turn claims priority from U.S. provisional application No. 60/968,638 filed Aug. 29, 2007. Both of these applications are hereby incorporated herein by reference.

### TECHNICAL FIELD

This invention relates to electrochemical cells, and more particularly, the invention relates to rechargeable, electrochemical cells having a sintered cathode and solid electrolyte in combination with an adjacent liquid electrolyte.

### BACKGROUND OF THE INVENTION

A battery cell is a useful article that provides stored electrical energy that can be used to energize a multitude of devices, particularly portable devices that require an electrical power source. The cell is an electrochemical apparatus typically formed of at least one ion-conductive electrolyte medium disposed between a pair of spaced-apart electrodes commonly known as an anode and a cathode.

Typically, electrode and electrolyte cell components are chosen to provide the most effective and efficient battery for a particular purpose. Lithium is a desirable active anode material because of its light weight and characteristic of providing a favorable reduction potential with several active cathode materials. Thus lithium as an anode material enables a cell to provide favorable energy output in comparison to its overall weight. This quality is often termed “energy density.” Lithium metal anodes are preferred over materials such as silicon and lithium-intercalating carbon that employ lithium as active material because even though lithium contributes to energy density when intercalated in such materials, the presence of the non-active material increases the weight and volume of the cell and, therefore, lowers energy density of the cell. Cells containing lithium metal are preferred over many types of other cells such as lithium-ion, nickel metal hydride and nickel-cadmium cells because the lithium metal anode provides a higher energy density. Thus, lithium metal anodes, or anodes comprising primarily lithium metal, are favored.

Despite the benefits that can be provided by lithium metal as an anode material, lithium metal can be problematic in an electrochemical cell. The problems associated with the use of lithium metal are related to its interaction with other materials in a cell and/or the ambient environment. For example, one problem associated with lithium metal as an active anode material is the incompatibility of lithium metal with air, water and certain non-aqueous solvents. More specifically, lithium metal can be degraded and/or otherwise react undesirably with such common mediums as air and water, and certain solvents. In some instances the reaction can be so unfavorable as to create a hazardous condition such as fire. The lithium metal characteristic of reacting unfavorably with liquid electrolyte is particularly problematic when it is desirable to use a liquid electrolyte medium but the chosen liquid reacts unfavorable with lithium. Liquid electrolytes are favorable because they are particularly effective in conducting and exchanging ions in an electrochemical cell.

Another problem associated with the use of lithium metal as an anode material is the possibility of internal failure of the cell. Even when lithium metal is used with a liquid electrolyte that does not react undesirably with lithium, internal failures during operation of the cell still can be a problem. One type of internal failure is the discharge of electric current internally, within the cell, rather than externally of the cell. Internal discharge may also be referred to as “self-discharge.” Self-discharge can result in high current generation, overheating and ultimately, a fire. A primary cause of self-discharge has been dendritic lithium growth during recharge of a rechargeable battery. In rechargeable cells having lithium anodes, dendrites are protuberances extending from the anode base which form during imperfect re-plating of the anode during recharge. Dendrites or growths resulting from low-density lithium plating during recharge can grow through the separator that separates anode from cathode particularly if the separator is porous or solid but easily punctured by the growth. When the growths extend far enough to interconnect the anode and cathode, an internal electrical short circuit is created through which current can flow. Electrical current produces heat that will vaporize a volatile electrolyte substance. In turn, vaporization of the electrolyte can produce extreme pressure within the battery housing or casing which can ultimately lead to rupture of the housing or casing. The temperatures that result from an electrical short circuit within a battery are sometimes high enough to ignite escaping electrolyte vapors thereby causing continuing degradation and the release of violent levels of energy.

Solutions have been proposed for the protection of lithium anodes including coating the lithium anode with interfacial or protective layers formed from polymers, ceramics, or glasses, the important characteristic of such interfacial or protective layers being to conduct lithium ions. For example, U.S. Pat. Nos. 5,460,905 and 5,462,566 to Skotheim describe a film of an n-doped conjugated polymer interposed between the alkali metal anode and the electrolyte. U.S. Pat. No. 5,648,187 to Skotheim and U.S. Pat. No. 5,961,672 to Skotheim et al. describe an electrically-conducting cross-linked polymer film interposed between the lithium anode and the electrolyte, and methods of making the same, where the cross-linked polymer film is capable of transmitting lithium ions. U.S. Pat. No. 5,314,765 to Bates describes a thin layer of a lithium-ion-conducting ceramic coating between the anode and the electrolyte. Yet further examples of interfacial films for lithium-containing anodes are described, for example, in U.S. Pat. Nos. 5,387,479 and 5,487,959 to Koksbang; U.S. Pat. No. 4,917,975 to De Jonghe et al.; U.S. Pat. No. 5,434,021 to Fauteux et al.; and U.S. Pat. No. 5,824,434 to Kawakami et al.

Generally, the problems associated with lithium-metal anodes used in conjunction with a liquid electrolyte in a cell are not encountered when a non-liquid, solid-state type of electrolyte is used. However, solid-state electrolytes, such as, for example, LiPON, typically have limitations with respect to interaction with effective cathode material that adversely affect reduction at the cathode. One such problem is that diffusion into cathode material is not as efficient with a solid-state electrolyte as with a liquid electrolyte.

Thus it can be appreciated that it would be useful to have a cell electrolyte medium that is an effective conductor of ions, that is protective of and stable in contact with lithium, that does not produce short circuits that are associated with dendritic plating of lithium, that facilitates efficient cathode reaction and from which a battery cell can be produced that is easy to fabricate, has long cycle life, has high lithium-cycling efficiency, and has high energy density.

### SUMMARY OF THE INVENTION

The present invention provides a hybrid electrolyte structure that alleviates the deficiencies of the prior art.

According to the present invention, an electrochemical cell has an anode of electrochemically-active material; a cathode of electrochemically-active, porous, liquid-permeable, sintered, ceramic material; and a solid-state, liquid-impermeable electrolyte medium disposed between the anode and cathode.

In an embodiment of the invention, the electrochemically-active, porous, liquid-permeable, sintered, ceramic cathode material is intercalatable material. In an aspect of this embodiment, the intercalatable material comprises at least one of the group of materials consisting of

LiNiₓCO₂₋ₓMnₓO₂, wherein 0≦x≦0.5;

### LiCoO₂;

LiNiₓCO₁₋ₓO₂, wherein 0.1≦x≦0.9;

### LiMn₂O₄; and

### LiFePO₄.

In an embodiment of the invention, the solid-state, liquid-impermeable electrolyte medium is affixed to said cathode.

In an embodiment of the invention, the solid-state, liquid-impermeable electrolyte medium is an amorphous or glass material. In an aspect of this embodiment, the solid-state, liquid-impermeable electrolyte medium is thin-film glass material. In a further aspect, the thin-film glass material is coated upon the cathode.

In an embodiment of the invention, the solid-state, liquid-impermeable electrolyte medium comprises ceramic material. In an aspect of this embodiment, the ceramic material is glass ceramic material. In a further aspect, the glass ceramic material comprises a lithium super-ionic-conductor polycrystalline ceramic material. In still a further aspect, the lithium super-ionic-conductor polycrystalline ceramic material comprises at least one lithium-metal phosphate from the group having a formula Li₁₊ₓ₊ᵣ(Ti_{2-y}Ge_{y})₂₋ₓ(Al_{2-z}Ga_{z})ₓSiᵣP_{3-y}O₁₂ where 0.0≦x≦0.9, 0.0≦y≦2.0, 0.0≦z≦2.0 and 0.0≦r≦1.0. In yet a further aspect, the lithium-metal phosphate contains a predominant crystalline phase comprising at least one of
Li₁₊ₓ(M, Al, Ga)ₓ(Ge_{1-y}Ti_{y})₂₋ₓ(PO₄)₃ where X≦0.8 and 0≦Y≦1.0, and where M is an element selected from the group consisting of Nd, Sm, Eu, Gd, Tb, Dy, Ho, Er, Tm, and Yb and
a compound having the formula Li_{1+x+y}QₓTi₂₋ₓSi_{y}P_{3-y}O₁₂ where 0≦X≦0.4 and 0≦Y≦0.6, where Q is Al or Ga.

In an embodiment of the invention, the solid-state, liquid-impermeable electrolyte medium comprises a layer of glass ceramic material disposed adjacent a layer of glass material wherein the layer of glass material is disposed adjacent the anode. In an aspect of this embodiment, the glass material is thin-film glass. In a different aspect of this embodiment the glass material comprises at least one of a lithium silicate, a lithium borate, a lithium aluminate, a lithium phosphate, a lithium phosphorus oxynitride, a lithium silicosulfide, a lithium germanosulfide, a lithium lanthanum oxide, a lithium titanium oxide, a lithium borosulfide, a lithium aluminosulfide, a lithium phosphosulfide and a lithium lanthanum zirconate. In a facet of this aspect, the preceding glass material is thin-film glass. In a different aspect of this embodiment, the glass ceramic material comprises a lithium super-ionic-conductor polycrystalline ceramic material. In a facet of this aspect, the lithium super-ionic-conductor polycrystalline ceramic material comprises at least one lithium-metal phosphate from the group having a formula Li₁₊ₓ₊ᵣ(Ti_{2-y}Ge_{y})₂₋ₓ(Al_{2-z}Ga_{z})ₓSiᵣP_{3-y}O₁₂ where 0.0≦x≦0.9, 0.0≦y≦2.0, 0.0≦z≦2.0 and 0.0≦r≦1.0. In a further facet, the lithium-metal phosphate contains a predominant crystalline phase comprising at least one of
Li₁₊ₓ(M, Al, Ga)ₓ(Ge_{1-y}Ti_{y})₂₋ₓ(PO₄)₃ where X≦0.8 and 0≦Y≦1.0, and where M is an element selected from the group consisting of Nd, Sm, Eu, Gd, Tb, Dy, Ho, Er, Tm, and Yb and
a compound having the formula Li_{1+x+y}QₓTi₂₋ₓSi_{y}P_{3-y}O₁₂ where 0≦X≦0.4 and 0≦Y≦0.6, where Q is Al or Ga.

In an embodiment of the invention, a liquid electrolyte is infused substantially throughout the cathode.

In an embodiment of the invention, the electrochemically-active material of the anode comprises lithium metal.

### BRIEF DESCRIPTION OF THE DRAWINGS

FIG. 1 is a schematic representation of a rechargeable lithium battery cell according to an embodiment of the present invention.

FIG. 2 is a schematic representation of a rechargeable lithium battery cell according to a second embodiment of the present invention.

### DETAILED DESCRIPTION

Embodiments of the present invention are described herein. The disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, at least some specific structural and functional details disclosed herein are not to be interpreted as limiting, but merely as a basis for the claims and as a representative basis for teaching one skilled in the art to variously employ the present invention.

It is to be understood that the present invention is not limited to the particular methodology, compounds, materials, manufacturing techniques, uses, and applications described herein, as these may vary. It is also to be understood that the terminology used herein is used for the purpose of describing particular embodiments only, and is not intended to limit the scope of the present invention.

Unless defined otherwise, all technical and scientific terms used herein have the same meanings as commonly understood by one of ordinary skill in the art to which this invention belongs. Exemplary methods, techniques, devices, and materials are described, although any methods, techniques, devices, or materials similar or equivalent to those described herein may be used in the practice or testing of the present invention. Structures described herein are to be understood also to refer to functional equivalents of such structures.

All patents and other publications identified are incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason.

### OVERVIEW

Liquid electrolytes are desirable in electrochemical cells because they provide a high degree of ionic conductivity. Lithium metal is desirable as an anode in electrochemical cells because it provides high energy density, is light-weight, is readily available and is relatively inexpensive. A problem exists, however, in that liquid electrolytes are often incompatible with lithium metal. Part of the problem is that many liquids react unfavorably with lithium metal causing degradation leading to ineffective use of the lithium as an anode and/or leading to reactions that can destroy the cell and, sometimes, can create a hazard such as fire. Another part of the problem is that upon repeated successive discharging and charging a lithium metal anode, when used with a liquid electrolyte, can become ineffective and/or can create conditions that can destroy the cell and, sometimes, can create a hazard such as fire.

The invention eliminates problems associated with the combination of a lithium metal anode and a liquid electrolyte while preserving many of the advantages by interposing a solid electrolyte between the liquid electrolyte and a lithium metal anode. The invention utilizes a cathode having a porous body structure that optimizes contacting surface area for liquid electrolyte. In addition, a solid electrolyte separator is used that contributes to ion conductivity while at the same time shields the anode from the liquid electrolyte thus preventing undesirable effects of interaction between the anode and liquid electrolyte. The solid electrolyte separator conducts ions but is impermeable with respect to liquids. This solid electrolyte facilitates the desired electrochemical reaction but does not permit liquid electrolyte to come into contact with the anode. The solid electrolyte may include more than one layer thus forming a multi-layer solid electrolyte. These features are described in greater detail below. The invention provides a reliable, rechargeable lithium battery cell that can be discharged and recharged effectively many times (typically referred to as “cycling efficiency”) and that is relatively easy to fabricate.

### General Structure of Cell of the Invention

Referring now to the drawings, wherein like numerals indicate like elements throughout the several views, the drawings illustrate certain of the various aspects of exemplary embodiments.

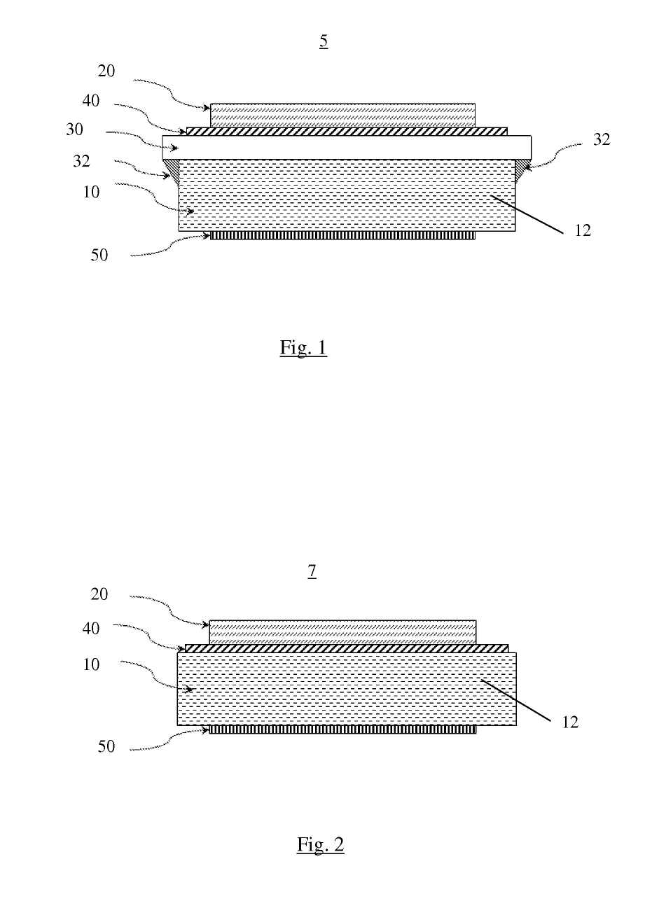

Referring first to FIG. 1, therein is illustrated a schematic representation of a sectional view of a rechargeable battery cell 5 according to an embodiment of the invention. A cathode 10 and an anode 20 are disposed spaced apart from one another. The cathode 10 is sintered, porous and infusible with a liquid electrolyte 12. At least one solid, liquid-impermeable electrolyte is disposed between and separates and adjoins the cathode 10 and the anode 20. In the embodiment illustrated in FIG. 1, one solid, liquid-impermeable electrolyte is a first solid, ion-conductive separator 30 disposed adjacent the cathode. The first separator 30 may be a ceramic material and, in particular, may be glass ceramic material. The first separator 30 may be affixed to the cathode such as by means of a polymer binder. The cell 5 may additionally include another solid, nonporous electrolyte, which is a second solid, ion-conductive separator 40, disposed adjacent the first separator 30. The second separator 40 may be solid amorphous material such as glass. A current collector 50 is disposed adjacent an outer surface of the cathode 10.

Referring now to FIG. 2, therein is illustrated a schematic representation of a sectional view of a rechargeable battery cell 7 according to a second embodiment of the invention. In this embodiment, only a single liquid-impermeable, solid electrolyte 10 is used. The other elements are the same as those employed in the first embodiment illustrated in FIG. 1. A cathode 10 and an anode 20 are disposed spaced apart from one another. The cathode 10 may be porous and infused with a liquid electrolyte 12. A solid, liquid-impermeable electrolyte is disposed between and separates and adjoins the cathode 10 and the anode 20. In the embodiment illustrated in FIG. 2, one solid, liquid-impermeable electrolyte is a first solid, ion-conductive separator 30 disposed adjacent the cathode. The separator 30 may be a ceramic material and, in particular, may be glass ceramic material. The first separator 30 may be affixed to the cathode such as by means of a polymer binder.

The cell 5, 7 taught by the invention may be considered a “hybrid” cell because it employs both a liquid electrolyte 12 and at least one solid electrolyte 30, 40. A sintered cathode provides a porous structure that helps enhance the functionality of the cell.

### The Cathode

The cell taught by the invention is made more effective through the use of a porous cathode 10 that is infused with a liquid electrolyte 12. A porous cathode 10 provides an increased surface area of reactant (effectively more reactant) for participation in the electrochemical reactions for the cell 5, 7. Effective cathode reactant surface area is further increased by using a thick, porous cathode 10.

The thick cathode 10 is fabricated from cathode active powder material that is sintered at elevated temperature to form a rigid but porous structure. The cathode material is chosen for high electronic conductivity as well as energy density so that no additive such as carbon black is required for electronic conductivity. Carbon black is normally employed in conventional, un-sintered composite cathodes used in lithium-ion batteries. The electronic conductivity is retained or enhanced during sintering. The cathode particle size distribution and sintering parameters can be used to control the porosity of the cathode for subsequent optimal incorporation and access of liquid electrolyte. In addition, for ease of fabrication, the full solid-state (that is, electrodes and solid electrolyte(s)) battery structure can be completed prior to infusion of liquid electrolyte into the cathode. In fact, the full-solid state battery structure with sintered cathode, solid electrolyte separator, and lithium anode can be cycled “dry” to confirm the integrity of the electrolyte separator prior to the addition of the liquid electrolyte.

The cathode structure 10 is formed from a material that is tape-casted from a slurry consisting of the cathode powder, a solvent, a binder and plasticizer onto a Mylar sheet with a release layer using standard tape casting methods. The dried casting is cut to a desired shape. Multiple layers, typically three or more, are laminated together to the desired cathode thickness and calendered, or otherwise pressed, under high pressure to densify the structure. The cathode is then sintered with a controlled ramp/soak process to form a microporous structure with from about 10% to about 30% porosity and high electronic conductivity. The ramp/soak process is an application of heat at alternating increasing then level temperatures. The active cathode material may be one or more of the group of lithium-intercalation materials currently known in the art such as LiNiₓCO₂₋ₓMnₓO₂ where 0≦x≦0.5; LiCoO₂; LiNiₓCO₁₋ₓO₂ where 0.1≦x≦0.9; LiMn₂O₄; and LiFePO₄). A cathode current collector 50 such as Al, Ni, Cu, Au or other conductive metal may be affixed to one side of the sintered cathode. The current collector may be deposited using standard methods such as physical vapor deposition (PVD) vacuum methods, spin coating, spray coating or printing, to form a thin film of about 200 nm to about 500 nm.

### Solid Electrolyte Separator

A single-layer or multi-layer solid electrolyte separator 50 is bonded to or directly deposited on the side of the sintered cathode opposite the current collector. The separator provides a barrier that physically separates the liquid electrolyte (which is diffused throughout the cathode) from the lithium anode. In one embodiment a glass-ceramic plate from about 50 μm to about 500 μm thick is bonded to the cathode using a binder material 51. The choice of binder material may vary widely so long as it is inert with respect to the other materials in the cathode. Useful binders are those materials, usually polymeric, that allow for ease of processing of battery electrode composites and are generally known to those skilled in the art of electrode fabrication. Examples of useful binders include, but are not limited to, those selected from the group consisting of polytetrafluoroethylenes such as, but not limited to, Teflon®), polyvinylidene fluorides (PVDF), ethylene-propylene-diene (EPDM) rubbers, polyethylene oxides (PEO), UV-curable acrylates, and UV-curable methacrylates. (Teflon® is a registered trademark for synthetic resinous fluorine-containing polymers, which registration is owned by E.I. Du Pont De Nemours and Company.) The binder may be a polymer gel electrolyte in which case it can be applied across the entire interface between the cathode and the glass ceramic electrolyte plate. If a non-ionic conductive binder is employed, it may be used to secure the perimeter of the cathode to the glass-ceramic plate. When bound together as described herein, the surfaces of the cathode and glass ceramic plate are maintained in close proximity to one another to allow the liquid electrolyte to form a bridge between the surfaces of the two components for effective lithium-ion transport.

The glass ceramic is a single rigid plate of ion-conducting material having high ionic conductivity. Suitable materials include the class of materials known as superionic conductors such as Lithium Super-Ion Conductor (LiSlCON) polycrystalline ceramics selected from the group comprising lithium metal phosphates. The lithium-metal phosphates have the formula Li₁₊ₓ₊ᵣ(Ti_{2-y}Ge_{y})₂₋ₓ(Al_{2-z}Ga_{z})ₓSiᵣP_{3-y}O₁₂, wherein (0.0≦x≦0.9); (0.0≦y≦2.0); (0.0≦z≦2.0); and (0.0≦r≦1.0). These compounds contain a predominant crystalline phase composed of at least one of or a combination of
Li₁₊ₓ(M,Al,Ga)ₓ(Ge_{1-y}Ti_{y})₂₋ₓ(PO₄)₃, where X≦0.8 and 0≦Y≦1.0, and where M is an element selected from the group consisting of Nd, Sm, Eu, Gd, Tb, Dy, Ho, Er, Tm and Yb
and
Li_{1+x+y}QₓTi₂₋ₓSi_{y}P_{3-y}O₁₂; where 0≦X≦0.4 and 0≦Y≦0.6, and where Q is Al or Ga.

If the glass ceramic plate is not chemically stable in contact with lithium, an additional thin-film, solid electrolyte barrier is placed between the electrolyte separator plate and the lithium anode. Appropriate single, ion-conducting layers for use as the second layer in the separator of the present invention include, but are not limited to, glassy layers comprising a glassy material selected from the group consisting of lithium silicates, lithium borates, lithium aluminates, lithium phosphates, lithium phosphorus oxynitrides, lithium silicosulfides, lithium germanosulfides, lithium lanthanum oxides, lithium titanium oxides, lithium borosulfides, lithium aluminosulfides, and lithium phosphosulfides, and combinations thereof. In an embodiment, the single ion-conducting layer comprises a lithium phosphorus oxynitride (LiPON). Electrolyte films of lithium phosphorus oxynitride are disclosed, for example, in U.S. Pat. No. 5,569,520 to Bates. A thin-film layer of lithium phosphorus oxynitride interposed between a lithium anode and an electrolyte is disclosed, for example, in U.S. Pat. No. 5,314,765 to Bates. The selection of the second single, ion-conducting layer is dependent on a number of factors including, but not limited to, the properties of liquid electrolyte and cathode used in the cell.

—Methodology of Preparing Multi-Layer Solid Electrolyte—The use of the glass ceramic separator 30 that is illustrated in the embodiment of FIG. 1 enables fast fabrication methods to be used with high yield. However, if the glass ceramic material is not chemically stable in contact with lithium metal as the anode first it may be coated with a thin film of an alternate solid electrolyte 40 such as LiPON or lithium lanthanum zirconate (LLZO). If a LiPON coating is employed, it may be deposited onto the glass ceramic plate 30 as a thin coating, from about 0.5 to about 10 μm thick. The LiPON may be applied to the glass ceramic material prior to the time that it is bonded to the cathode 30. Bonding may be accomplished using standard physical vapor deposition (PVD) vacuum methods such as but not limited to sputtering. On the other hand, in an aspect of an embodiment of the invention, a coating of lithium lanthanum zirconate (LLZO) may be applied using a sol-gel process and materials as described in U.S. patent application Ser. No. 12/848,991 filed by D. Babic et al. on Aug. 2, 2010. In this sol-gel process a solution comprising organic precursors of the constituent components of the LLZO, in the required ratios, is spin-coated, spray-coated or printed onto the glass ceramic as a liquid and then hydrolyzed, gelled, and dried to form a conformal, pinhole-free, protective coating of solid LLZO electrolyte on the glass ceramic plate. The lithium-metal anode 20 which is chemically stable in contact with both LiPON and LLZO can then be evaporated directly onto the coating of the now-protected glass ceramic separator.

In the embodiment illustrated in FIG. 2, only a single separator layer 40 is employed between the sintered cathode 10 and anode 20. The thin, solid electrolyte layer (such as LiPON or LLZO) is directly deposited directly on the sintered cathode. A current collector 50 is coated on the side of the cathode opposite the side affixed to or affixable to the electrolyte separator. The thicker intermediate glass-ceramic plate is not employed in this embodiment. A much thinner layer (from about 0.2 to about 10 μm) of LiPON may be deposited by RF sputtering. However, in an aspect of this embodiment, a conformal ceramic electrolyte separator coating of lithium lanthanum zirconate is applied to the cathode using a sol-gel process. Elimination of the glass-ceramic plate in these applications leads to a significant increase in gravimetric and volumetric energy density of the battery. This embodiment requires that the thin-film solid electrolyte coating is stable in contact with lithium and has low impedance in contact with the liquid electrolyte chosen as the ionically-conducting additive to the porous cathode. Also, the surface of the cathode must be fabricated with very low surface roughness such that the deposited solid electrolyte coatings form a conformal, contiguous, pinhole free layer on the cathode.

### The Cell

The cell structure comprises the sintered cathode impregnated with liquid electrolyte and coated with a thin-film current collector on one side. On the other side of the cathode is a single-layer or multi-layer separator that completely protects a lithium metal anode from contact with the liquid electrolyte that is diffused throughout the cathode. The multi-layer separator consists of a single, ion-conducting glass ceramic plate coated with a thin film coating of another single, ion-conducting layer that is non-reactive with lithium metal that protects the glass-ceramic plate from contact with and, thereby, chemical reaction with the lithium metal anode. In another embodiment, as illustrated in FIG. 2, the glass ceramic plate is eliminated and the single thin-film separator is deposited directly onto the sintered cathode.

Example of Construction of Cells in Accordance with Embodiments of the Invention

Cells in accordance with the teachings of the invention were constructed as described here. The cathode material was tape-casted from a slurry onto a Mylar® sheet with a release layer. Mylar® is a registered trademark for a brand of polyester film or plastic sheet which trademark is owned by DuPont Tejjin Films. The dried casting was cut to a desired shape or punched into discs that were laminated together and calendered to densify the structure. The resulting substrate (sometimes referred to as a “pellet”) was then sintered with a controlled known ramp/soak process to form a porous structure with from about 10 to about 30% porosity and high electronic conductivity. A cathode current collector such as Al, Ni, Cu, Au or other conductive metal was deposited using standard physical vapor deposition (PVD) vacuum methods or spin or spray coated or printed on as a thin film of 200-500 nm onto one side of the pellet. A solid electrolyte separator was then deposited or bonded to the other side of the pellet. In one embodiment a glass-ceramic plate 100-500 μm thick was bonded to the cathode using a binder material. If a material such as lithium lanthanum titanate is employed that is not chemically stable in contact with lithium metal, the superionic conductor can first be coated with an alternate solid electrolyte such as LiPON (lithium phosphorus oxynitride) or amorphous lithium lanthanum zirconate before putting it in contact with lithium. This layer is deposited as a thin coating from about 0.5 to about 10 μm thick onto the glass ceramic plate. It can be deposited using standard physical vapor deposition (PVD) vacuum methods such as sputtering or spin or spray coated or printed on in a sol gel process.

The invention provides an electrochemical cell that has the desirable characteristics of both a lithium-metal anode and a liquid electrolyte but also protects the lithium metal from degradation by liquid electrolyte and inhibits dendrite formation during recycling. The cell is able to obtain high energy density available from lithium metal anode and effective discharge and recharging facilitated by use of liquid electrolyte. The invention takes full advantage of the stability of the solid-state interface between the solid electrolyte and a lithium metal anode and at the same time uses liquid electrolyte in a sintered rigid cathode to gain access to the enlarged surface area of much thicker cathodes than what is possible using existing, solid-state, thin-film batteries. By achieving access to thick cathodes but enabling the use of the higher voltage and much higher energy density of lithium metal as compared to lithium intercalation anodes of conventional batteries, the hybrid battery of the present invention allows for much improved energy density and specific energy.

Many variations and modifications may be made to the above-described embodiments without departing from the scope of the claims. All such modifications, combinations, and variations are included herein by the scope of this disclosure and the following claims. For example, invention has been described in the context of lithium metal anodes. However, anodes made of other metals also possess some of the desirable traits of lithium metal anodes and also incur some of the problems associated with lithium metal anodes. Thus the teachings of the invention are applicable also to anodes made of other metals.

What is claimed is:

1. An electrochemical cell comprising:
an anode comprising electrochemically-active material;
a cathode comprising electrochemically-active, porous, liquid-permeable, sintered, ceramic material; and
a solid-state, liquid-impermeable electrolyte medium disposed between said anode and said cathode.

2. The electrochemical cell of claim 1, said cathode having porosity of from about 10% to about 30%.

3. The electrochemical cell of claim 1, wherein said electrochemically-active, porous, liquid-permeable, sintered, ceramic material of said cathode comprises an intercalatable material.

4. The electrochemical cell of claim 3, wherein said intercalatable material comprises at least one of the group of materials consisting of
LiNiₓCO₂₋ₓMnₓO₂, wherein 0≦x≦0.5;
LiCoO₂;
LiNiₓCO₁₋ₓO₂, wherein 0.1≦x≦0.9;
LiMn₂O₄; and
LiFePO₄.

5. The electrochemical cell of claim 1, wherein said solid-state, liquid-impermeable electrolyte medium is affixed to said cathode.

6. The electrochemical cell of claim 1, wherein a perimeter of said solid-state, liquid-impermeable electrolyte medium is affixed to said cathode by binder material.

7. The electrochemical cell of claim 1, wherein said binder material comprises at least one of a polytetrafluoroethylene, a polyvinylidene fluoride, an ethylene-propylene-diene rubber, a polyethylene oxide, a UV-curable acrylate, and a UV-curable methacrylate.

8. The electrochemical cell of claim 1, wherein said solid-state, liquid-impermeable electrolyte medium is affixed to said cathode in face-contacting relationship.

9. The electrochemical cell of claim 1, wherein said solid-state, liquid-impermeable electrolyte medium is affixed to said cathode in face-contacting relationship by a polymer-gel electrolyte binder.

10. The electrochemical cell of claim 1, wherein said solid-state, liquid-impermeable electrolyte material comprises amorphous material.

11. The electrochemical cell of claim 1, wherein said solid-state, liquid-impermeable electrolyte material comprises glass material.

12. The electrochemical cell of claim 1, wherein said solid-state, liquid-impermeable electrolyte material comprises thin-film glass material.

13. The electrochemical cell of claim 1, wherein said solid-state, liquid-impermeable electrolyte material comprises thin-film glass material coated upon said cathode.

14. The electrochemical cell of claim 1, wherein said solid-state, liquid-impermeable electrolyte medium comprises ceramic material.

15. The electrochemical cell of claim 1, wherein said solid-state, liquid-impermeable electrolyte medium comprises glass ceramic material.

16. The electrochemical cell of claim 15, wherein said glass ceramic material is about 50 to about 500 μm thick.

17. The electrochemical cell of claim 15, wherein said glass ceramic material comprises a lithium super-ionic-conductor polycrystalline ceramic material.

18. The electrochemical cell of claim 17, wherein said lithium super-ionic-conductor polycrystalline ceramic material comprises at least one lithium-metal phosphate from the group having a formula Li₁₊ₓ₊ᵣ(Ti_{2-y}Ge_{y})₂₋ₓ(Al_{2-z}Ga_{z})ₓSiᵣP_{3-y}O₁₂ where 0.0≦x≦0.9, 0.0≦y≦2.0, 0.0≦z≦2.0 and 0.0≦r≦1.0.

19. The electrochemical cell of claim 18, wherein said at least one lithium-metal phosphate contains a predominant crystalline phase comprising at least one of
Li₁₊ₓ(M, Al, Ga)ₓ(Ge_{1-y}Ti_{y})₂₋ₓ(PO₄)₃ where X≦0.8 and 0≦Y≦1.0, and where M is an element selected from the group consisting of Nd, Sm, Eu, Gd, Tb, Dy, Ho, Er, Tm, and Yb and
a compound having the formula L_{1+x+y}QₓTi₂₋ₓSi_{y}P_{3-y}O₁₂ where 0≦X≦0.4 and 0≦Y≦0.6, where Q is Al or Ga.

20. The electrochemical cell of claim 1, wherein said solid-state, liquid-impermeable electrolyte medium comprises a layer of glass ceramic material disposed adjacent a layer of glass material wherein said layer of glass material is disposed adjacent said anode.

21. The electrochemical cell of claim 20, wherein said glass material comprises thin-film glass material.

22. The electrochemical cell of claim 20, wherein said glass material comprises at least one of a lithium silicate, a lithium borate, a lithium aluminate, a lithium phosphate, a lithium phosphorus oxynitride, a lithium silicosulfide, a lithium germanosulfide, a lithium lanthanum oxide, a lithium titanium oxide, a lithium borosulfide, a lithium aluminosulfide, a lithium phosphosulfide and a lithium lanthanum zirconate.

23. The electrochemical cell of claim 22, wherein said glass material comprises thin-film glass material.

24. The electrochemical cell of claim 20, wherein said glass ceramic material is from about 50 to about 500 μm thick.

25. The electrochemical cell of claim 20, wherein said glass ceramic material comprises a lithium super-ionic-conductor polycrystalline ceramic material.

26. The electrochemical cell of claim 25, wherein said lithium super-ionic-conductor polycrystalline ceramic material comprises at least one lithium-metal phosphate from the group having a formula Li₁₊ₓ₊ᵣ(Ti_{2-y}Ge_{y})₂₋ₓ(Al_{2-z}Ga_{z})ₓSiᵣP_{3-y}O₁₂ where 0.0≦x≦0.9, 0.0≦y≦2.0, 0.0≦z≦2.0 and 0.0≦r≦1.0.

27. The electrochemical cell of claim 26, wherein said at least one lithium-metal phosphate contains a predominant crystalline phase comprising at least one of
Li₁₊ₓ(M, Al, Ga)ₓ(Ge_{1-y}Ti_{y})₂₋ₓ(PO₄)₃ where X≦0.8 and 0≦Y≦1.0, and where M is an element selected from the group consisting of Nd, Sm, Eu, Gd, Tb, Dy, Ho, Er, Tm, and Yb and
a compound having the formula L_{1+x+y}QₓTi₂₋ₓSi_{y}P_{3-y}O₁₂ where 0≦X≦0.4 and 0≦Y≦0.6, where Q is Al or Ga.

28. The electrochemical cell of claim 1, further comprising a liquid electrolyte infused substantially throughout said cathode.

29. The electrochemical cell of claim 1, wherein said electrochemically-active material of said anode comprises lithium metal.
